(19) United States
(12) Patent Application Publication
(10) Pub. No.: US 2025/0227400 A1
(43) Pub. Date: Jul. 10, 2025

(54) Vehicle Electroacoustic Transducer

(71) Applicant: FOSTER ELECTRIC COMPANY, LIMITED, Tokyo (JP)

(72) Inventors: Gaku Kubota, Akishima-shi, Tokyo (JP); Atsushi Koga, Akishima-shi, Tokyo (JP)

(21) Appl. No.: 18/851,655

(22) PCT Filed: Mar. 6, 2023
(86) PCT No.: PCT/JP2023/008418

§ 371 Date: Sep. 26, 2024

(30) Foreign Application Priority Data
Mar. 29, 2022 (JP) 2022-053455

(51) Int. Cl. H04R 1/02

(52) U.S. Cl. CPC H04R 1/026; H04R 1/025; H04R 2499/13

(57) ABSTRACT

A vehicle electroacoustic transducer includes a speaker unit that generates sound, and a case that is formed in a box shape, that accommodates the speaker unit, and that includes an attachment face disposed facing an attached member outside of a vehicle cabin, and an attachment portion that bulges out from the attachment face and that is attached to the attached member, and a boss portion that bulges out from the attachment face and that contacts the attached member, are formed at the case.

### TECHNICAL FIELD

The present invention relates to a vehicle electroacoustic transducer.

### RELATED ART

Japanese Patent Application Laid-Open (JP-A) No. 2021-29003 and Japanese Patent Application Laid-Open (JP-A) No. 2021-29004 disclose vehicle electroacoustic transducers each including a speaker unit fixed inside a main body case. In the vehicle electroacoustic transducers described in Japanese Patent Application Laid-Open (JP-A) No. 2021-29003 and Japanese Patent Application Laid-Open (JP-A) No. 2021-29004, an internal space and an external space of the main body case are partitioned using a vibrating body as a boundary, and by providing a ventilation member in a communication hole that communicates the spaces with each other, air is allowed to pass through, while fluid is blocked from passing through.

### SUMMARY OF THE INVENTION

### Problem to be Solved by the Invention

However, the vehicle electroacoustic transducers described in Japanese Patent Application Laid-Open (JP-A) No. 2021-29003 and Japanese Patent Application Laid-Open (JP-A) No. 2021-29004 are configured to be attached to an attached member at plural locations, and there is room for improvement from the perspective of improving work efficiency during attachment. On the other hand, in cases in which the vehicle electroacoustic transducer is attached to the attached member at only one location, there is a possibility that the case will resonate when the vehicle electroacoustic transducer is actuated. Incidentally, when the case resonates, durability of an attachment portion is reduced. In particular, in a vehicle electroacoustic transducer provided outside of a vehicle cabin, greater durability is required compared to a device provided inside the vehicle cabin. Thus, suppression of resonance and improvement in durability are desired.

An object of the present invention is to provide a vehicle electroacoustic transducer that is capable of suppressing resonance of a case while improving work efficiency during attachment.

### Means for Solving the Problem

A vehicle electroacoustic transducer according to a first aspect includes: a speaker unit that generates sound; and a case that is formed in a box shape, that accommodates the speaker unit, and that includes an attachment face disposed facing an attached member outside of a vehicle cabin, wherein an attachment portion that bulges out from the attachment face and that is attached to the attached member, and a boss portion that bulges out from the attachment face and that contacts the attached member, are formed at the case.

In the above aspect, the speaker unit is accommodated at the case that is formed in a box shape. Further, the case includes the attachment face that is disposed facing the attached member, and the attachment portion bulges out from the attachment face. Consequently, the case can be attached to the attached member by simply attaching the attachment portion to the attached member.

Further, the boss portion bulges out from the attachment face, and the boss portion contacts the attached member. Consequently, in a state in which the case is attached to the attached member, the case is supported at plural locations of the attachment portion and the boss portion, and resonance of the case can be suppressed. Furthermore, since a gap is provided between the case and the attached member except for at the attachment portion and the boss portion, the speaker unit can avoid being affected by heat, even in environments in which a temperature at the attached member side becomes high.

A vehicle electroacoustic transducer according to a second aspect is the vehicle electroacoustic transducer according to the first aspect, wherein the attachment portion is formed at one end side of the attachment face, and the boss portion is formed at another end side of the attachment face.

In the above aspect, since at least both end sides of the attachment face contact the attached member, resonance of the case can be effectively suppressed.

A vehicle electroacoustic transducer according to a third aspect is the vehicle electroacoustic transducer according to the first aspect or the second aspect, wherein a height of the boss portion with respect to the attachment face is greater than a height of the attachment portion with respect to the attachment face.

In the above aspect, the boss portion can be reliably contacted with the attached member when the attachment portion is attached to the attached member. Further, due to the boss portion being pressed against the attached member, generation of abnormal noise due to vibration of the case can be suppressed.

A vehicle electroacoustic transducer according to a fourth aspect is the vehicle electroacoustic transducer according to any one of the first aspect to the third aspect, wherein plural boss portions are formed.

In the above aspect, by forming plural boss portions, the case can be supported more stably compared with a configuration in which one boss portion is provided.

A vehicle electroacoustic transducer according to a fifth aspect is the vehicle electroacoustic transducer according to the fourth aspect, wherein a leading end of the attachment portion is formed as a flat face, and a leading end of the boss portion is formed in a spherical shape.

In the above aspect, since the leading end of the attachment portion is formed as a flat face, the attachment portion and the attached member can be attached in a state in which they are in surface contact with each other, and an attachment state thereof can be stabilized. Further, by configuring the leading end of the boss portion so as to have a spherical shape, the case can be supported by the boss portion in a state in which the boss portion and the attached member are in point contact with each other.

A vehicle electroacoustic transducer according to a sixth aspect is the vehicle electroacoustic transducer according to any one of the first aspect to the fifth aspect, wherein the boss portion contacts the attached member before the attachment portion when the attachment portion is attached to the attached member.

In the above aspect, since the boss portion contacts the attached member before the attachment portion, the attachment portion can be positioned in a state in which the boss portion is contacted with the attached member.

### Effect of the Invention

According to the vehicle electroacoustic transducer of the present invention, resonance of a case can be suppressed while improving work efficiency during attachment.

### BRIEF DESCRIPTION OF THE DRAWINGS

FIG. 1 is an exploded perspective view of a vehicle electroacoustic transducer according to an exemplary embodiment.

FIG. 2 is a cross-sectional view in which the vehicle electroacoustic transducer according to the exemplary embodiment is viewed from a left side.

FIG. 3 is a perspective view of the vehicle electroacoustic transducer according to the exemplary embodiment, and is a view illustrating a state prior to insertion of an attachment fitting.

FIG. 4 is a top view of the vehicle electroacoustic transducer according to the exemplary embodiment.

FIG. 5 is a cross-sectional view taken along line 5-5 in FIG. 4.

### MODE FOR IMPLEMENTING THE INVENTION

A vehicle electroacoustic transducer 10 according to an exemplary embodiment will be explained, with reference to the drawings. It should be noted that in the respective drawings as appropriate, arrow FR, arrow UP, and arrow RH respectively indicate a front direction, an upper direction, and a right direction of the vehicle electroacoustic transducer 10. However, a front-rear direction, an up-down direction, and a left-right direction of the vehicle electroacoustic transducer 10 are established for convenience of explanation, and do not necessarily coincide with a front-rear direction, an up-down direction, and a left-right direction in a state in which the vehicle electroacoustic transducer 10 has been attached to an attached member.

### Overall Configuration of Vehicle Electroacoustic Transducer 10

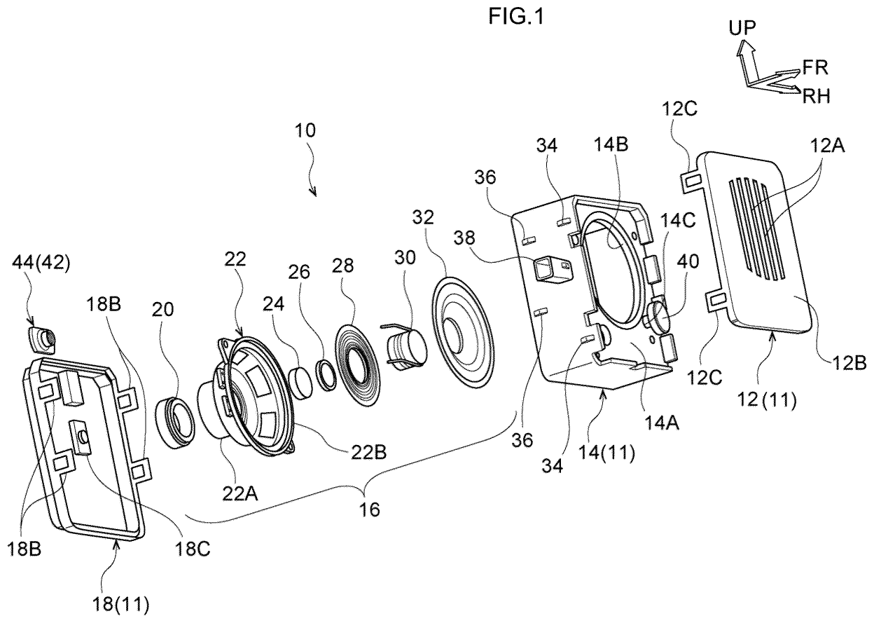

As illustrated in FIG. 1, the vehicle electroacoustic transducer 10 of the present exemplary embodiment is mainly configured to include a front cover 12, a case main body 14, a speaker unit 16, and a rear cover 18. Further, a case 11 is configured by the front cover 12, the case main body 14, and the rear cover 18, and the speaker unit 16 is accommodated at the case 11.

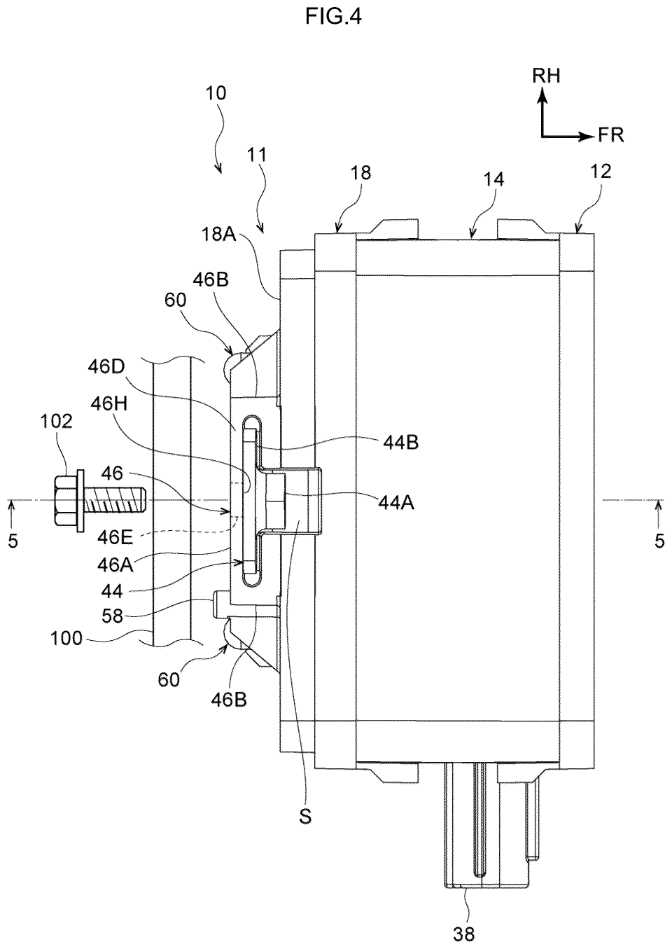

In this regard, as an example, the vehicle electroacoustic transducer 10 of the present exemplary embodiment is installed at a power unit chamber provided outside of a vehicle cabin of a vehicle, and is configured so as to be attached to an attached member 100 (refer to FIG. 4) installed at the power unit chamber. Further, as an example, the vehicle electroacoustic transducer 10 of the present exemplary embodiment is used as a vehicle approach notification device (acoustic vehicle alerting system (AVAS)) that generates sound during low-speed travel in a state of being installed at the vehicle, to thereby notify a pedestrian of approaching of the vehicle.

First, the speaker unit 16 configuring the vehicle electroacoustic transducer 10 of the present exemplary embodiment will be explained, and thereafter, the front cover 12, the case main body 14, and the rear cover 18 configuring the case 11 will be explained in detail.

### Speaker Unit 16

The speaker unit 16 is mainly configured to include a yoke 20, a frame 22, a magnet 24, a top plate 26, a damper 28, a voice coil 30, and a diaphragm 32.

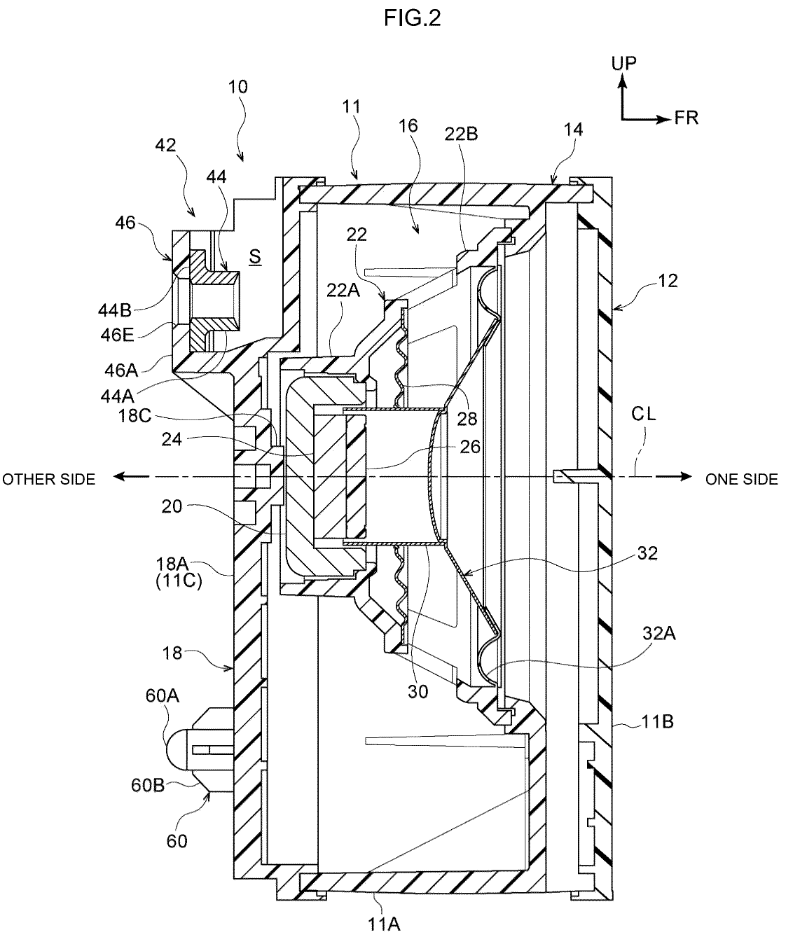

As illustrated in FIG. 2, the frame 22 has a substantially stepped cylindrical shape including a small diameter portion 22A and a tapered portion 22B, and is formed of a resin member as an example. Further, the small diameter portion 22A of the frame 22 is disposed at a rear side, the tapered portion 22B is disposed at a front side, and a center axis CL direction of the frame 22 coincides with the front-rear direction. In the following explanation, the front side of the speaker unit 16 including the frame 22 is sometimes referred to as one side in the center axis CL direction, and the rear side of the speaker unit 16 is sometimes referred to as the other side in the center axis CL direction.

An end portion (axial direction other end portion) at the axial direction other side of the tapered portion 22B is connected to the small diameter portion 22A, and the tapered portion 22B is formed in a shape that is gradually increased in diameter toward the axial direction one side from the axial direction other end portion. The diaphragm 32 is attached to an end portion (axial direction one end portion) at the axial direction one side of the tapered portion 22B.

A diameter of the diaphragm 32 is gradually increased from the axial direction other end side toward the axial direction one end side, and the voice coil 30 is attached to a rear face of a center portion of the diaphragm 32. Further, an annular groove portion 32A that is convex toward the axial direction other end side is formed at an outer peripheral end portion of the diaphragm 32. A portion of the diaphragm 32 further toward an outer peripheral side than the groove portion 32A is fixed to the axial direction one end portion of the frame 22, and an opening at the axial direction one end side of the frame 22 is closed off by the diaphragm 32.

Furthermore, an axial direction one side portion of the frame 22 is connected to an axial direction one end portion of the case main body 14, which will be described later. Thus, an external space and an internal space of the case main body 14 are partitioned by the diaphragm 32.

Meanwhile, the yoke 20, the magnet 24, and the top plate 26 are provided at an inner side of the small diameter portion 22A of the frame 22. The yoke 20 has a bottomed cylindrical shape in which a front side thereof is open, and is formed of a magnetic body. Further, a front end portion of the yoke 20 is in contact with the frame 22, and a rear end portion of the yoke 20 is in contact with the rear cover 18. Thus, the yoke 20 is held in a state of being sandwiched between the frame 22 and the rear cover 18, which will be described later.

The magnet 24 has a substantially columnar shape with a smaller diameter than the yoke 20, and the magnet 24 of the present exemplary embodiment is formed of a neodymium magnet, as an example. Further, the magnet 24 is disposed at an inner side of the yoke 20, and a rear face of the magnet 24 is in contact with a bottom portion of the yoke 20.

The top plate 26 is laminated at a front side of the magnet 24. The top plate 26 has a substantially columnar shape that is thinner than the magnet 24, and is formed of a magnetic body. A magnetic circuit is configured by the yoke 20, the magnet 24, and the top plate 26.

A gap is provided between the top plate 26 and the yoke 20, and an axial direction other end portion of the voice coil 30 is inserted into the gap. The voice coil 30 is formed by winding a conducting wire around a bobbin, which is not illustrated in the drawings, in a cylindrical shape, and an outside diameter of the voice coil 30 is slightly larger than the magnet 24 and the top plate 26. An axial direction one end portion of the voice coil 30 is fixed to the center portion of the diaphragm 32, and the diaphragm 32 is configured to be deformed according to displacement of the voice coil 30.

The damper 28 is fixed to an outer peripheral face of the voice coil 30. The damper 28 is substantially disc-shaped with a radial direction center portion thereof being open, and is formed of a member having flexibility. Further, the damper 28 is formed with a substantially wave-shaped cross-section, an inner peripheral end portion of the damper 28 is fixed to an axial direction center portion of the voice coil 30, and an outer peripheral end portion of the damper 28 is fixed to the frame 22. Thus, the voice coil 30 is supported by the damper 28 so as to be capable of moving in an axial direction at an inner side of the frame 22.

In this regard, both end portions of the conducting wire configuring the voice coil 30 are connected to terminals, which are not illustrated in the drawings, and electric power is supplied to the voice coil 30 from a power source at an exterior of the vehicle electroacoustic transducer 10 via the terminals.

The speaker unit 16 is configured as described above, and due to electric power being supplied to the voice coil 30 and current flowing through the voice coil 30, the voice coil 30 reciprocates in the axial direction to cause the diaphragm 32 to vibrate. Due to the diaphragm 32 being caused to vibrate, sound is generated.

### Overall Configuration of Case 11

Next, the case 11 at which the speaker unit 16 is accommodated will be explained.

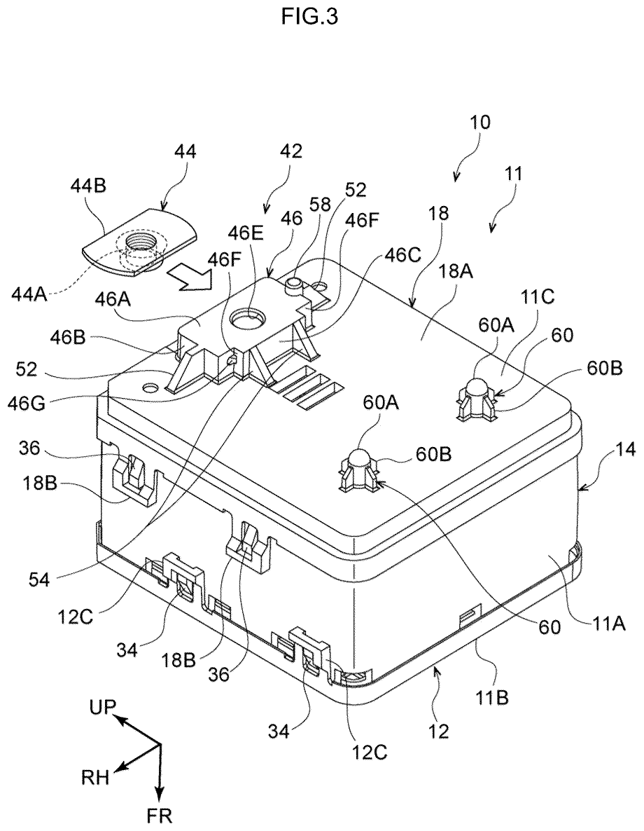

As illustrated in FIG. 3, the case 11 is formed in a box shape, accommodates the speaker unit 16, and is configured to include a peripheral wall portion 11A that surrounds a periphery of the speaker unit 16, a front wall portion 11B that is disposed at one end side (a front side) of the peripheral wall portion 11A, and a rear wall portion 11C that is disposed at another end side (a rear side) of the peripheral wall portion 11A.

Further, as illustrated in FIG. 1, the case 11 is formed substantially in a box shape including the case main body 14, the front cover 12, and the rear cover 18, the front cover 12 is attached to a front side of the case main body 14, and the rear cover 18 is attached to a rear side of the case main body 14. Thus, the peripheral wall portion 11A is configured by the case main body 14, the front wall portion 11B is configured by the front cover 12, and the rear wall portion 11C is configured by the rear cover 18. Moreover, the rear cover 18 is provided with an attachment face 18A that is disposed facing the attached member 100 (refer to FIG. 4). It should be noted that, although the case 11 has a three-part divided structure including the case main body 14, the front cover 12, and the rear cover 18 in the present exemplary embodiment, there is no limitation thereto, and an integral or two-part divided structure may be employed. Alternatively, a structure in which the case is divided into four or more parts may be employed.

### Case Main Body 14

The case main body 14 has a substantially square tube shape with both sides thereof being open, and is formed of a resin member of a fiber-reinforced resin or the like, as an example. The speaker unit 16 is held by the case main body 14. Further, a plurality of front side projecting portions 34 and a plurality of rear side projecting portions 36 are formed at an outer peripheral face of the case main body 14.

Two front side projecting portions 34 are formed at each of a right side face and a left side face at a front portion of the case main body 14, and are configured such that front side claw portions 12C of the front cover 12, which will be described later, are locked thereat. Further, two rear side projecting portions 36 are formed further toward the rear side than the front side projecting portions 34 at each of the right side face and the left side face of the case main body 14, and are configured such that rear side claw portions 18B of the rear cover 18, which will be described later, are locked thereat.

A connector 38 is provided at the left side face of the case main body 14. The connector 38 projects out leftward from the case main body 14, and a terminal or the like, which is not illustrated in the drawings, at an external device side is connected to the connector 38.

A partition wall 14A that partitions the internal space of the case main body 14 into a front side and a rear side, with a plate thickness direction thereof being along the front-rear direction, is provided at the case main body 14. A circular through-hole 14B is formed at the partition wall 14A, and the through-hole 14B is configured so as to be closed off by the diaphragm 32 of the speaker unit 16.

Moreover, a plug 40 made of resin is provided at the partition wall 14A. The plug 40 is attached to a communication portion 14C formed at the partition wall 14A. The communication portion 14C is formed by a through-hole having a smaller diameter than that of the through-hole 14B, such that the external space at the front side of the partition wall 14A and the internal space at the rear side of the partition wall 14A are communicated with each other. Further, a filter member, which is not illustrated in the drawings, that permits passage of air and blocks passage of liquid is provided at the communication portion 14C, and the filter member is protected by the plug 40.

### Front Cover 12

The front cover 12 is disposed at the front side of the case main body 14, and the front cover 12 is attached to the front side (diaphragm 32 side) of the case main body 14. The front cover 12 has a substantially rectangular plate shape with a plate thickness direction thereof being along the front-rear direction, and is formed of a resin member of a fiber-reinforced resin or the like, as an example.

Further, plural slits 12A are formed at the front cover 12, and sound that has been generated due to vibrating of the diaphragm 32 of the speaker unit 16 passes through the slits 12A and is output to an exterior of the vehicle electroacoustic transducer 10.

In this regard, the plural slits 12A are formed along the left-right direction, and each slit 12A extends in the up-down direction. As an example, the slits 12A of the present exemplary embodiment have a labyrinth structure, and have a structure that suppresses infiltration of fluid from a front face (surface) to a rear face (back surface) of the front cover 12.

Further, the slits 12A are formed at a portion that faces the through-hole 14B of the case main body 14, and a portion of the front cover 12 that faces a site where the plug 40 (filter member) is provided configures a blocking portion 12B at which the slits 12A are not formed.

Four front side claw portions 12C are provided at the front cover 12. Specifically, two front side claw portions 12C extend out toward the rear side from a left side end portion of the front cover 12. Similarly, two front side claw portions, which are not illustrated in the drawings, extend out toward the rear side from a right side end portion of the front cover 12. A locking hole into which a front side projecting portion 34 of the case main body 14 enters is formed at each front side claw portion 12C, and the front cover 12 is locked due to the front side projecting portions 34 entering into the locking holes of the front side claw portions 12C.

### Rear Cover 18

The rear cover 18 is disposed at the rear side of the case main body 14, and the rear cover 18 is attached to the rear side (side that is opposite from the diaphragm 32) of the case main body 14. The rear cover 18 has a substantially rectangular plate shape with a plate thickness direction thereof being along the front-rear direction, and is formed of a resin member of a fiber-reinforced resin or the like, as an example. A space at the side of the case main body 14 that is opposite from the diaphragm 32 is sealed by the rear cover 18.

Four rear side claw portions 18B are provided at the rear cover 18. Specifically, two rear side claw portions 18B extend out toward the front side from a left side end portion of the rear cover 18. Similarly, two rear side claw portions 18B extend out toward the front side from a right side end portion of the front cover 12. A locking hole into which a rear side projecting portion 36 of the case main body 14 enters is formed at each rear side claw portion 18B, and the rear cover 18 is locked due to the rear side projecting portions 36 entering into the locking holes of the rear side claw portions 18B.

A support portion 18C is provided at a front face (back surface) of the rear cover 18. The support portion 18C bulges out toward the front side from the front face of the rear cover 18, and a leading end of the support portion 18C is formed in a substantially columnar shape. As illustrated in FIG. 2, in a state in which the vehicle electroacoustic transducer 10 has been assembled, a configuration is provided such that a rear face of the yoke 20 is pressed against the support portion 18C.

### Attachment Portion 42

As illustrated in FIG. 3, an attachment portion 42 that is attached to the attached member 100 is provided at the attachment face 18A, which is a rear face of the rear cover 18. In other words, the attachment portion 42 bulges out, from the rear wall portion 11C, toward a side that is opposite from the front wall portion 11B side, and is formed so as to be attachable to the attached member 100. The attachment portion 42 is formed at an outer side of the rear cover 18, and is configured to include an attachment fitting 44 into which a bolt 102 (refer to FIG. 4), serving as a fastener, is screwed, and a fitting accommodation portion 46 that accommodates the attachment fitting 44.

The fitting accommodation portion 46 is integrally formed with the case main body 14 so as to bulge out toward the rear from the attachment face 18A, and is formed in a substantially rectangular shape when viewed from the rear side. Specifically, the fitting accommodation portion 46 is configured to include a rear wall 46A, left and right side walls 46B, a lower wall 46C, and an upper wall 46D (refer to FIG. 4).

The rear wall 46A configures a rear portion of the fitting accommodation portion 46, and extends in the up-down direction and the left-right direction with a plate thickness direction thereof being along the front-rear direction. Further, an insertion hole 46E is formed at a center portion of the rear wall 46A. The insertion hole 46E is formed in a substantially circular shape, and has a size such that the bolt 102 for fastening the case 11 to the attached member 100 can be inserted therethrough (refer to FIG. 4).

The side walls 46B respectively extend out toward the front from both left and right end portions of the rear wall 46A, and each side wall 46B extends in the up-down direction and the front-rear direction with a plate thickness direction thereof being along the left-right direction. Reinforcing ribs 52 are respectively provided at the side walls 46B. Each of the reinforcing ribs 52 is formed in a substantially trapezoidal shape when viewed along a plate thickness direction thereof, with the plate thickness direction thereof being along the up-down direction. The respective left and right side walls 46B and the attachment face 18A are coupled to each other by the reinforcing ribs 52.

In this regard, a pin 58 for positioning is formed at the left side wall 46B. The pin 58 is integrally formed with the fitting accommodation portion 46, and projects out further toward the rear side than the rear wall 46A. Further, the pin 58 is formed in a substantially columnar shape, and is inserted into a positioning hole, which is not illustrated in the drawings, that is formed at the attached member 100.

The lower wall 46C extends out toward the front from a lower end portion of the rear wall 46A, and the lower wall 46C extends in the front-rear direction and the left-right direction with a plate thickness direction thereof being along the up-down direction. Further, a left and right pair of reinforcing ribs 54 are provided at the lower wall 46C. Each of the reinforcing ribs 54 is formed in a substantially triangular shape when viewed from a plate thickness direction thereof, with the plate thickness direction thereof being along the left and right direction. The lower wall 46C and the attachment face 18A are coupled to each other by the reinforcing ribs 54.

In this regard, corner portions 46F having inward-corner shapes are provided between the left and right side walls 46B and the lower wall 46C. A cutout portion 46G for draining water is formed at each of the left and right pair of corner portions 46F. Each cutout portion 46G is formed extending between a side wall 46B and the lower wall 46C, and is configured so as to be capable of draining water from two directions, namely, the up-down direction and the left-right direction. It should be noted that, in FIG. 3, only the cutout portion 46G that is formed at the left corner portion 46F is visible, but that a cutout portion 46G is also formed in the same manner at the right corner portion 46F.

Thus, in the present exemplary embodiment, as an example, the cutout portions 46G are formed at plural locations of the fitting accommodation portion 46. Each cutout portion 46G is formed by penetrating a portion of the corner portion 46F in a circular shape. Further, the cutout portions 46G are formed at a side of the fitting accommodation portion 46 that is opposite from an insertion hole 46H, which will be described later, in the up-down direction.

As illustrated in FIG. 4, the upper wall 46D extends out toward the front from an upper end of the rear wall 46A, and extends in the front-rear direction and the left-right direction with a plate thickness direction thereof being along the up-down direction. The insertion hole 46H into which the attachment fitting 44 can be inserted is formed at the upper wall 46D.

When viewed from an upper face, the insertion hole 46H is formed substantially in a T-shape including a left-right extending portion that extends to the left and right, and a front-rear extending portion that extends toward the front side from a center portion of the left-right extending portion. Further, the front-rear extending portion of the insertion hole 46H extends further toward the front than the attachment face 18A of the rear cover 18. Thus, the attachment portion 42 is formed in a shape that enables the attachment fitting 44 to be attached and detached with a gap S provided between the fitting accommodation portion 46 and the attachment fitting 44 in a state in which the attachment fitting 44 is accommodated in the fitting accommodation portion 46. The gap S is provided between the fitting accommodation portion 46 and the attachment fitting 44 at the front-rear extending portion and the left-right extending portion of the insertion hole 46H.

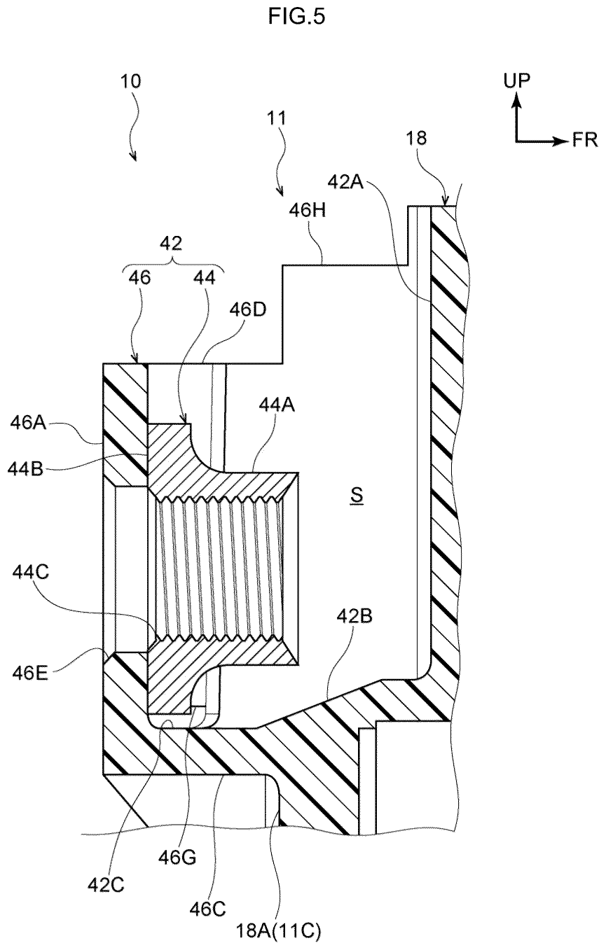

As illustrated in FIG. 5, an inner wall of the fitting accommodation portion 46 of the attachment portion 42 is configured to include an up-down wall portion 42A, an inclined portion 42B, and a front-rear wall portion 42C, as viewed from the left-right direction. The up-down wall portion 42A configures an inner wall at a front side of the insertion hole 46H, and extends in the up-down direction. The up-down wall portion 42A extends further upward than the rear wall 46A that faces thereto in the front-rear direction.

The inclined portion 42B and the front-rear wall portion 42C configure a bottom wall of the insertion hole 46H, and extend in the front-rear direction. In this regard, the front-rear wall portion 42C extends toward the front side from a lower end of the rear wall 46A to a front-rear direction center portion of the insertion hole 46H. The front-rear wall portion 42C and the up-down wall portion 42A are linked by the inclined portion 42B.

The inclined portion 42B is inclined downward from the up-down wall portion 42A toward the front-rear wall portion 42C. Both left and right end portions of the front-rear wall portion 42C are respectively connected to edge portions forming the cutout portions 46G. In other words, the inclined portion 42B formed at the inner wall of the fitting accommodation portion 46 is inclined toward the cutout portions 46G.

As illustrated in FIG. 3 and FIG. 4, the attachment fitting 44 is formed as a separate body from the case 11. The attachment fitting 44 is a so-called T-type nut including a tube-shaped portion 44A and a flange portion 44B, and in the present exemplary embodiment, the attachment fitting 44 is formed of a steel material, as an example.

The flange portion 44B extends out from the tube-shaped portion 44A in a radial direction of the tube-shaped portion 44A with a plate thickness direction thereof being along the front-rear direction. Further, the flange portion 44B is formed in a laterally long shape in which, among the two directions orthogonal to the plate thickness direction, a length thereof in one direction is longer than a length thereof in the other direction. In the present exemplary embodiment, the flange portion 44B extends in the left-right direction and the up-down direction, and is formed in a laterally long shape in which a length thereof in the left-right direction is longer than a length thereof in the up-down direction.

Further, a threaded hole 44C that communicates with the insertion hole 46E in a state in which the attachment fitting 44 is accommodated at the fitting accommodation portion 46, and into which the bolt 102 is screwed, is formed at the tube-shaped portion 44A of the attachment fitting 44. Specifically, as illustrated in FIG. 5, in a state in which the attachment fitting 44 has been inserted into the insertion hole 46H of the fitting accommodation portion 46, the threaded hole 44C that is formed at the attachment fitting 44 communicates with the insertion hole 46E of the fitting accommodation portion 46.

The attachment portion 42 is configured as described above, and the attachment portion 42 of the case 11 is fixed to the attached member 100 by inserting the bolt 102 through the insertion hole 46E of the fitting accommodation portion 46, and screwing the bolt 102 into the threaded hole 44C of the attachment fitting 44. At that time, the attached member 100 and the rear wall 46A of the fitting accommodation portion 46 are in a state of being sandwiched between the attachment fitting 44 and the bolt 102.

### Boss 60

As illustrated in FIG. 3, two boss portions 60 bulge out from the attachment face 18A of the case 11. Among the two boss portions 60, one boss portion 60 is provided in a vicinity of a lower right corner portion of the attachment face 18A, and the other boss portion 60 is provided in a vicinity of a lower left corner portion of the attachment face 18A. In other words, the attachment portion 42 is formed at one end side of the attachment face 18A, and the boss portions 60 are formed at the other end side of the attachment face 18A.

Further, each boss portion 60 is configured to include a main body portion 60A and ribs 60B. The main body portion 60A is formed in a substantially columnar shape, and a leading end of the main body portion 60A is formed in a substantially spherical shape. Four ribs 60B are formed at equal intervals around the main body portion 60A. The respective ribs 60B connect the main body portion 60A and the attachment face 18A to each other.

In this regard, as illustrated in FIG. 2, the leading ends of the main body portions 60A of the boss portions 60 are positioned further toward the rear side than the rear wall 46A of the fitting accommodation portion 46 configuring the attachment portion 42. That is to say, heights of the boss portions 60 with respect to the attachment face 18A are greater than a height of the attachment portion 42 with respect to the attachment face 18A. Thus, when the case 11 is attached to the planar attached member 100, the boss portions 60 contact the attached member 100 before the attachment portion 42. Then, the main body portions 60A of the boss portions 60 are pressed against the attached member 100.

### Operation

Next, operation of the present exemplary embodiment will be explained.

In the vehicle electroacoustic transducer 10 according to the present exemplary embodiment, the speaker unit 16 is accommodated at the case 11. Further, as illustrated in FIG. 3, the case 11 is configured to include the peripheral wall portion 11A, the front wall portion 11B, and the rear wall portion 11C. Furthermore, since the attachment portion 42 is formed at the case 11, the case 11 can be attached to the attached member 100 via the attachment portion 42.

In this regard, the attachment portion 42 bulges out from the rear wall portion 11C of the case 11 toward the side (the rear side) that is opposite from the front wall portion 11B side. Consequently, the case can be attached in a smaller space compared with a configuration in which the attachment portion is provided at a periphery of the peripheral wall portion 11A. That is to say, in a configuration in which flanges are extended out from the peripheral wall portion 11A of the case 11 in the left-right direction or the up-down direction, there is a possibility that the flanges will interfere with peripheral components. In contrast thereto, in the vehicle electroacoustic transducer 10 of the present exemplary embodiment, since the attachment portion 42 is provided at a position that overlaps with the case 11 in the front-rear direction, the case 11 can be attached to the attached member 100, even in a case in which other components are disposed at the periphery of the peripheral wall portion 11A.

Further, in the present exemplary embodiment, a so-called outsert structure is employed in which the attachment fitting 44 is inserted into the insertion hole 46H of the fitting accommodation portion 46. Consequently, deterioration of an interface between the case 11 and the attachment fitting 44 due to influence of water or the like can be suppressed, compared with an insert structure in which the attachment fitting 44 is integrally molded with the fitting accommodation portion 46 (the case 11).

Furthermore, as illustrated in FIG. 4, in the present exemplary embodiment, when the case 11 is attached to the attached member 100 by the bolt 102, which serves as a fastener, the bolt 102 and the attachment fitting 44 are screwed together in a state in which the bolt 102 is inserted into the insertion hole 46E formed at the fitting accommodation portion 46. Consequently, since the rear wall 46A of the fitting accommodation portion 46 is sandwiched between the attachment fitting 44 and the bolt 102, the case 11 can be more firmly attached to the attached member 100. By attaching the case 11 to the attached member 100 via the fitting accommodation portion 46, an area that is in contact with the attached member 100 can be increased, and a load can be distributed.

Moreover, in the present exemplary embodiment, by configuring the flange portion 44B of the attachment fitting 44 with a laterally long shape, an impact can be dispersed by the flange portion 44B, even in a case in which the impact has been input to the attachment portion 42 from the attached member 100 side. Further, in a case in which the flange portion 44B has a circular shape with a large diameter, a size of the fitting accommodation portion 46 itself needs to be increased; however, by configuring the flange portion 44B with a laterally long shape, the length thereof in the up-down direction can be reduced, and there is no need to increase the size of the fitting accommodation portion 46. Furthermore, by configuring the flange portion 44B with a laterally long shape, rotation of the attachment fitting 44 due to the flange portion 44B contacting the fitting accommodation portion can be suppressed.

Further, in the present exemplary embodiment, since the gap S is provided between the fitting accommodation portion 46 and the attachment fitting 44, the attachment fitting 44 can be easily attached and detached. Consequently, work efficiency of work for inserting the attachment fitting 44 into the fitting accommodation portion 46 can be improved. Furthermore, the attachment fitting 44 can be easily changed according to a standard or the like of the attached member 100.

Moreover, as illustrated in FIG. 3, in the present exemplary embodiment, since the cutout portions 46G for water draining are formed at the fitting accommodation portion 46, water can be drained from the cutout portion 46G, even in a case in which water has entered into the fitting accommodation portion 46, and water can be inhibited from remaining in the fitting accommodation portion 46.

In particular, in the present exemplary embodiment, since the cutout portions 46G are formed at the corner portions 46F at both left and right sides of the fitting accommodation portion 46, water can be inhibited from remaining at the corner portions 46F. Further, compared with a configuration in which the cutout portion 46G is formed at only one location, water drainage performance can be further improved.

Furthermore, in the present exemplary embodiment, the insertion hole 46H is formed at the upper end portion of the fitting accommodation portion 46, and the cutout portions 46G are formed at the lower end portion of the fitting accommodation portion 46, which is at the side thereof that is opposite from the insertion hole 46H. Consequently, water can be drained from the cutout portions 46G, even in a case in which water has entered from the insertion hole 46H deep into the fitting accommodation portion 46.

Moreover, as illustrated in FIG. 5, in the present exemplary embodiment, the inclined portion 42B is formed at the inner wall of the insertion hole 46H, and water that has entered into the fitting accommodation portion 46 is guided to the cutout portions 46G by the inclined portion 42B. Consequently, water within the fitting accommodation portion 46 can be drained with good efficiency. Thus, according to the vehicle electroacoustic transducer 10 of the present exemplary embodiment, deterioration of the case 11 due to residual water can be suppressed.

Further, as illustrated in FIG. 3, in the above exemplary embodiment, the boss portions 60 bulge out from the attachment face 18A of the case 11, and the boss portions 60 are in contact with the attached member 100. Consequently, in a state in which the case 11 is attached to the attached member 100, the case 11 is supported at plural locations of the attachment portion 42 and the boss portions 60, and resonance of the case 11 can be suppressed.

In particular, in the present exemplary embodiment, the attachment portion 42 is provided at the upper portion of the attachment face 18A, and the two boss portions 60 are provided at the lower portion of the attachment face 18A. Consequently, since the case 11 contacts the attached member 100 at three locations, resonance of the case 11 can be effectively suppressed. Further, since a gap is provided between the case 11 and the attached member 100 except for at the attachment portion 42 and the boss portions 60, the speaker unit 16 can avoid being affected by heat, even in environments in which a temperature at the attached member 100 side becomes high.

Furthermore, in the present exemplary embodiment, since the boss portions 60 are formed projecting out further toward the rear side than the attachment portion 42, the boss portions 60 can be reliably contacted with the attached member 100 when the attachment portion 42 is attached to the attached member 100.

Further, since the boss portions 60 contact the attached member 100 before the attachment portion 42, the attachment portion 42 can be positioned in a state in which the boss portions 60 are contacted with the attached member 100. Then, due to the boss portions 60 being pressed against the attached member 100, generation of abnormal noise due to vibration of the case 11 can be suppressed. That is to say, in a case in which the height of the attachment portion 42 with respect to the attachment face 18A and the heights of the boss portions 60 with respect to the attachment face 18A are configured to be the same height, there is a possibility that a slight gap will be provided between the boss portions 60 and the attached member 100 due to design error, assembly error, or the like. In such cases, there is a possibility that abnormal noise will be generated by contact between the boss portions 60 and the attached member 100 due to vibration of the diaphragm 32 upon actuation of the vehicle electroacoustic transducer 10.

In contrast thereto, by adopting a configuration in which the boss portions 60 are pressed against the attached member 100, as in the present exemplary embodiment, a slight gap is not provided between the boss portions 60 and the attached member 100, and generation of abnormal noise can be suppressed.

Further, in the present exemplary embodiment, since the leading end of the attachment portion 42, that is to say, the rear wall 46A of the fitting accommodation portion 46, is formed as a flat face, the attachment portion 42 and the attached member 100 can be attached in a state in which they are in surface contact with each other, and an attachment state thereof can be stabilized.

In contrast thereto, since the leading ends of the boss portions 60 are configured to have spherical shapes, the case 11 can be supported by the boss portions 60 in a state in which the boss portions 60 and the attached member 100 are in point contact with each other.

Further, in the present exemplary embodiment, the front cover 12 is attached to the diaphragm 32 side (the front side) of the case main body 14, and the rear cover 18 is attached to the side (the rear side) of the case main body 14 that is opposite from the diaphragm 32. Thus, by providing a configuration in which the front cover 12 and the rear cover 18 are included separately from the case main body 14 that holds the speaker unit 16, a design of only the case main body 14 may be changed when changing a design of the speaker unit 16. That is to say, the speaker unit 16 can be held as long as the internal structure of the case main body 14 is changed in accordance with the change in design of the speaker unit 16. Further, as long as the external structure of the case main body 14 is not changed, the front cover 12 and the rear cover 18 can be attached in the same manner as before the change in design.

Furthermore, in the present exemplary embodiment, it is possible to cope with changes in the application and the usage environment of the vehicle electroacoustic transducer 10 simply by changing the front cover 12 or the rear cover 18. In particular, in the present exemplary embodiment, since the attachment portion 42 is formed at the rear cover 18, the vehicle electroacoustic transducer 10 can be attached merely by changing the rear cover 18 according to the specifications of the attached member 100. For example, in an environment in which fastening portions at plural locations are required, as long as the rear cover 18 is changed to prepare a rear cover at which plural attachment portions 42 are formed, the vehicle electroacoustic transducer 10 can be attached without changing the designs of the case main body 14 and the front cover 12.

Moreover, in the present exemplary embodiment, the space at the rear side of the case main body 14 is sealed by the rear cover 18, and the attachment portion 42 is formed at the outer side of the rear cover 18. Thus, foreign matter can be inhibited from entering the interior of the case main body 14 from the rear cover 18 side, compared with a configuration in which the attachment portion 42 is in communication with the internal space of the case main body 14.

Further, as illustrated in FIG. 1, in the present exemplary embodiment, the external space and the internal space of the case main body 14 are in communication with each other through the communication portion 14C. Consequently, even in a case in which temperature, atmospheric pressure, or the like has changed between the external space and the internal space of the case main body 14, due to air entering and exiting between the external space and the internal space through the communication portion 14C, deformation of the diaphragm 32 can be suppressed. Further, since liquid is prevented from passing through the communication portion 14C by the filter member, inflow of liquid into the internal space of the case main body 14 can be suppressed.

Furthermore, in the above aspect, sound that has been output from the speaker unit 16 is transmitted to the exterior through the slits 12A formed at the front cover 12. Further, since the portion facing the plug 40 that protects the filter member is the blocking portion 12B, the filter member can be well protected, even in a case in which foreign matter, water droplets, or the like have been blown onto the front cover 12.

### Supplementary Explanation

Although the vehicle electroacoustic transducer 10 according to the exemplary embodiment has been explained above, it is needless to say that various aspects can be implemented in a range that does not depart from the spirit of the present invention. For example, although the attachment portion 42 is provided at the upper end portion of the attachment face 18A in the above exemplary embodiment as illustrated in FIG. 3, there is no limitation thereto, and the attachment portion 42 may be provided at another location. That is to say, the attachment portion 42 may be provided at a center portion of the attachment face 18A. Alternatively, a configuration may be provided in which plural attachment portions 42 are provided at the attachment face 18A.

Further, although the two boss portions 60 are provided at the attachment face 18A in the above exemplary embodiment, there is no limitation thereto. For example, a configuration may be provided in which three or more boss portions 60 are provided.

Furthermore, although the leading ends of the boss portions 60 are formed in a spherical shape in the above exemplary embodiment, there is no limitation thereto. For example, the leading ends of the boss portions 60 may be formed in a substantially conical shape. In that case as well, the boss portions 60 and the attached member 100 can be brought into point contact with each other.

Moreover, although the speaker unit 16 that generates sound by reciprocating the voice coil 30 is employed in the above exemplary embodiment as illustrated in FIG. 1, there is no limitation thereto. For example, a speaker unit that generates sound using another structure may be employed.

Further, although a so-called outsert structure in which the attachment fitting 44 is inserted into the insertion hole 46H of the fitting accommodation portion 46 is employed in the above exemplary embodiment, there is no limitation thereto.

In the above exemplary embodiment, an example in which the attached member 100 is formed in a planar shape has been described. However, the attached member may be formed having a step (formed in a crank shape in cross-section) such that a portion contacted by the boss portions is positioned further forward, in the front-rear direction, than a portion contacted by the attachment portion, or may be formed having a step (formed in a crank shape in cross-section) so as to be positioned rearward in the front-rear direction. In such cases, it is sufficient as long as the boss portions are formed so as to contact the attached member before the attachment portion when the attachment portion is attached to the attached member.

The disclosure of Japanese Patent Application No. 2022-053455 is hereby incorporated into the present specification by reference in its entirety.

All documents, patent applications, and technical standards described in the present specification are hereby incorporated into the present specification by reference to the same extent as if each document, patent application, and technical standard were specifically and individually described as being incorporated by reference.

1. A vehicle electroacoustic transducer comprising:
a speaker unit that generates sound; and
a case that is formed in a box shape, that accommodates the speaker unit, and that includes an attachment face disposed facing an attached member,
wherein an attachment portion that bulges out from the attachment face and that is attached to the attached member outside of a vehicle cabin, and a boss portion that bulges out from the attachment face and that contacts the attached member, are formed at the case.

2. The vehicle electroacoustic transducer according to claim 1, wherein the attachment portion is formed at one end side of the attachment face, and the boss portion is formed at another end side of the attachment face.

3. The vehicle electroacoustic transducer according to claim 1, wherein a height of the boss portion with respect to the attachment face is greater than a height of the attachment portion with respect to the attachment face.

4. The vehicle electroacoustic transducer according to claim 1, wherein a plurality of boss portions are formed.

5. The vehicle electroacoustic transducer according to claim 1, wherein a leading end of the attachment portion is formed as a flat face, and a leading end of the boss portion is formed in a spherical shape.

6. The vehicle electroacoustic transducer according to claim 1, wherein the boss portion contacts the attached member before the attachment portion when the attachment portion is attached to the attached member.
